(19) United States
(12) Patent Application Publication
(10) Pub. No.: US 2009/0121711 A1
(43) Pub. Date: May 14, 2009

(54) THERMALLY STABILIZED MAGNETS FOR USE DOWNHOLE

(75) Inventor: Martin Blanz, Niedersachsen (DE)

Correspondence Address: CANTOR COLBURN, LLP, 20 Church Street, 22nd Floor, Hartford, CT, 06103, US

(73) Assignee: Baker Hughes Incorporated, Houston, TX (US)

(21) Appl. No.: 12/183,400

(22) Filed: Jul. 31, 2008

Related U.S. Application Data
(60) Provisional application No. 60/953,242, filed on Aug. 1, 2007.

(51) Int. Cl. G01V 3/32

(52) U.S. Cl. 324/303

(57) ABSTRACT

A logging instrument for estimating a property of a formation penetrated by a borehole, the instrument having a magnet disposed at least one of at and in the instrument wherein the magnet exhibits a magnetic field of “substantially” constant magnitude over a range of temperatures in the borehole.

### CROSS REFERENCE TO RELATED APPLICATION

The present application is filed under 37 CFR §1.53(b) and 35 U.S.C. §120 and claims priority to U.S. Provisional Patent Application Ser. No. 60/953,242, filed Aug. 1, 2008, the entire contents of which are specifically incorporated herein by reference in their entirety

### BACKGROUND OF THE INVENTION

1. Field of the Invention

The invention disclosed herein relates to nuclear magnetic resonance measurements. In particular, the invention relates to providing a thermally stable magnetic field.

2. Description of the Related Art

Geophysical exploration calls for drilling holes to great depths into the earth. The holes, known as “boreholes,” are used to provide access for measuring properties of geologic formations.

Well logging is a technique used to take measurements of the geologic formations from the boreholes. In one embodiment, a “logging instrument” is lowered on the end of a wireline into the borehole. The logging instrument sends data via the wireline to the surface for recording. In another embodiment, the logging instrument performs measurements while drilling and does not use the wireline. Output from the logging instrument comes in various forms and may be referred to as a “log.” One type of measurement involves using nuclear magnetic resonance (NMR) to measure properties of the geologic formations. An example of an NMR logging instrument for measurement-while-drilling is MAGTRAK produced by Baker Hughes Incorporated of Houston, Tex.

NMR uses a magnetic field to polarize nuclei for measuring NMR properties of the nuclei. In one embodiment, the magnetic field is provided by a permanent magnet. It is helpful to use a constant magnetic field magnitude to insure accurate measurements. However, the magnetic field magnitude can vary due to changes in temperature of the magnet. The temperature of the magnet can change because temperatures deep in the borehole are generally much higher than at the surface of the earth.

Standard permanent magnets have a negative temperature coefficient. The negative temperature coefficient signifies that the magnitude of the magnetic field of the magnet decreases reversibly with increasing temperature. There are several ways to compensate for the negative temperature coefficient.

One method calls for keeping the temperature of the magnet constant. Generally, this method requires that the magnet be heated to a temperature greater than the highest temperature expected downhole. There are several disadvantages to using this method. For one, extra apparatus such as a temperature controller is needed. For another, extra power is required for heating and the power must be distributed around the magnet. In addition, a time for thermal stabilization of the magnet may take several hours. Another consideration is that temperature stabilization requires a certain amount of insulation for which there is limited space in downhole applications. In particular, space is limited in NMR instruments that perform measurements while drilling. When it is not practical to heat the magnet such as in downhole NMR applications, signal compensation may be used.

A signal compensation method calls for varying a NMR spectrometer reference frequency proportional to the magnetic field intensity. When the spectrometer reference frequency is proportional to the magnetic field intensity, an NMR resonance condition will remain at a same location in the formation. The signal compensation method also has some disadvantages. One disadvantage is the requirement for extra electronics such as a variable frequency generator. Another disadvantage is that it may be necessary to retune an NMR sensor resonator and other associated resonators. In addition, as measurement conditions change (e.g., changed resonant pulse ringdown or changed electrical interference susceptibility), a changed magnetic field intensity and frequency may make calibration more difficult.

Another attempt to provide a constant magnetic field intensity calls for using an electromagnet. The electromagnet may be formed by winding a coil around a permanent magnet. The magnetic field from the coil can compensate for varying magnetic field intensity of the permanent magnet. Use of the electromagnet also has some disadvantages. For example, the coil requires additional electronics such as a control loop to adjust current to the coil. The coil also consumes additional power and needs space that may not be available in a downhole NMR instrument.

Another technique to provide temperature compensation is disclosed in U.S. Pat. No. 6,577,125 B2 entitled “Temperature Compensated Magnetic Field Apparatus For NMR Measurements” issued on Jun. 10, 2003 with continuation by U.S. Pat. No. 6,803,761 B2 entitled “Temperature Compensated Magnetic Circuit” issued on Oct. 12, 2004. Disclosed are “two magnets have different magnetic temperature coefficients with the same sign, and the angle between the direction of magnetization of the first magnet and that of the second magnet is approximately 180.degree[s].” One disadvantage of using two opposing magnetic fields is that a total magnetic field magnitude is less than the magnitude that would be available without the opposing of the magnetic fields.

Therefore, what are needed are techniques to provide a magnetic field with a “substantially” constant magnitude in an NMR instrument. Preferably, the techniques do not involve power consumption or require an assembly of magnets with opposing magnetic fields.

### BRIEF SUMMARY OF THE INVENTION

Disclosed is a logging instrument for estimating a property of a formation penetrated by a borehole, the instrument having a magnet disposed at least one of at and in the instrument wherein the magnet exhibits a magnetic field of “substantially” constant magnitude over a range of temperatures in the borehole.

Also disclosed is a method for performing a nuclear magnetic resonance (NMR) measurement in a borehole, the method including selecting a logging instrument adapted for use in the borehole, the instrument including a magnet that provides for a magnetic field of “substantially” constant magnitude over a range of temperatures in the borehole; and performing the NMR measurement with the instrument.

Further disclosed is a method for producing a logging instrument for performing a nuclear magnetic resonance measurement in a borehole, the method including selecting a magnet that provides for a magnetic field of “substantially” constant magnitude over a range of temperatures in the borehole; and placing the magnet into the instrument.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 illustrates an exemplary embodiment of a logging instrument in a borehole penetrating the earth;

FIGS. 2A and 2B, collectively referred to as FIG. 2, illustrate an exemplary embodiment of a thermally stabilized magnet;

FIG. 3 presents an exemplary method for performing a nuclear magnetic resonance measurement in a borehole; and

FIG. 4 presents an exemplary method for producing the logging instrument.

### DETAILED DESCRIPTION OF THE INVENTION

The teachings provide a magnet that is thermally stabilized for use in a logging instrument. The magnet provides a “substantially” constant magnetic field magnitude through a range of temperatures. “Substantially” in this context means a magnitude of variation of less than 0.02% per degree centigrade. In one embodiment, the magnet exhibits a temperature coefficient that has a value of “substantially” zero. The magnet is useful for performing nuclear magnetic resonance (NMR) measurements with the logging instrument. A benefit of the magnet is that the magnet provides for more accurate NMR measurements than previously achieved with permanent magnets that generally exhibit a negative temperature coefficient.

For convenience, certain definitions are provided. The term “temperature coefficient” refers to a mathematical factor that relates a change in magnitude of a magnetic field of a magnet to a change in temperature of the magnet. Equation (1) presents one example of the temperature coefficient in mathematical terms.

B(T)=B(T₀)(1+αΔT) (1)
where: B(T) represents the magnitude of the magnetic field generated by a magnet at temperature T, T₀ represents a reference temperature, α represents the temperature coefficient, and ΔT represents a change in temperature (T−T₀) of the magnet.
   A magnet with a negative temperature coefficient exhibits a decreasing magnetic field magnitude with increasing temperature. Conversely, a magnet with a positive temperature coefficient exhibits an increasing magnetic field magnitude with increasing temperature. With respect to determining the temperature coefficient, the magnetic flux in the magnet can be measured with an integrating flux meter. Alternatively, the magnetic field at a region of investigation outside of the logging instrument may be measured with a Hall sensor. While the teachings herein discuss magnetic fields, the term “magnetic field” relates also to magnetic flux density.

The term “thermally stabilized” relates to a magnet that exhibits a temperature coefficient of “substantially” zero over a range in temperature that is of interest to a user. A thermally stabilized magnet demonstrates little or no variation in the magnitude of the associated magnetic field with variations in temperature of the magnet over the range of temperatures expected in a borehole where the logging instrument operates. Temperatures in a borehole generally increase with depth. Consequently, logging instruments are designed to operate at temperatures up to about 175° C. or higher. The term “substantially” when used herein within quotation marks relates to a magnitude of variation of less than 0.02% per degree centigrade.

The term “nuclear magnetic resonance measurements” relates to measuring properties of a formation. The NMR measurements include measuring precession of nuclei in a polarizing magnetic field. The teachings herein provide a thermally stabilized magnet for providing the polarizing magnetic field.

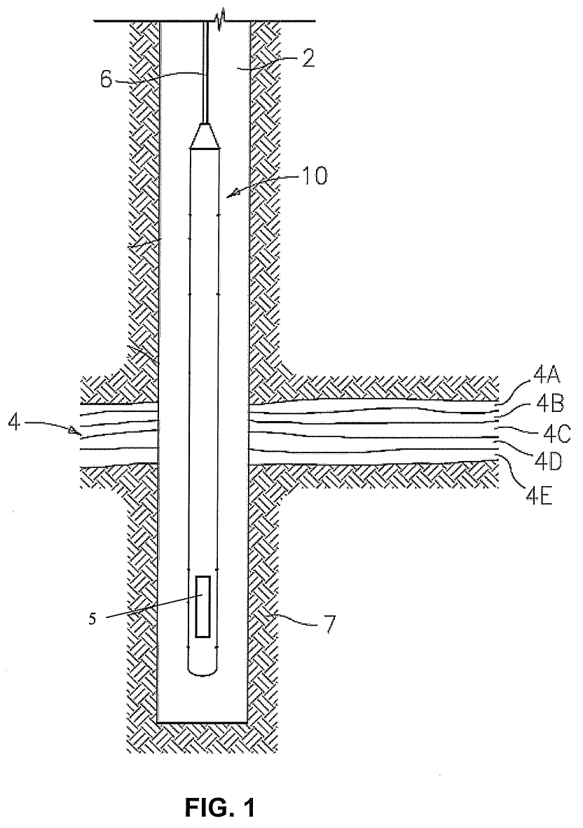

Referring to FIG. 1, a well logging instrument 10 is shown disposed in a borehole 2. The borehole 2 is drilled through earth 7 and penetrates formations 4, which include various formation layers 4A-4E. The logging instrument 10 is lowered into and withdrawn from the borehole 2 by use of an armored electrical cable 6 or similar conveyance as is known in the art. A magnet 5 is shown disposed within or at the logging instrument 10. As used herein, a non-limiting embodiment of the logging instrument 10 can include at least one of a housing, a chassis, electronics, wiring, and an antenna for performing nuclear magnetic resonance (NMR) measurements. One skilled in the art will recognize that the techniques disclosed herein can be applied with other embodiments, such as logging-while-drilling (LWD) or measurement-while-drilling (MWD) operations. In LWD application, the logging instrument 10 is part of a bottom hole assembly (BHA) at the bottom of the drill string above the drill bit.

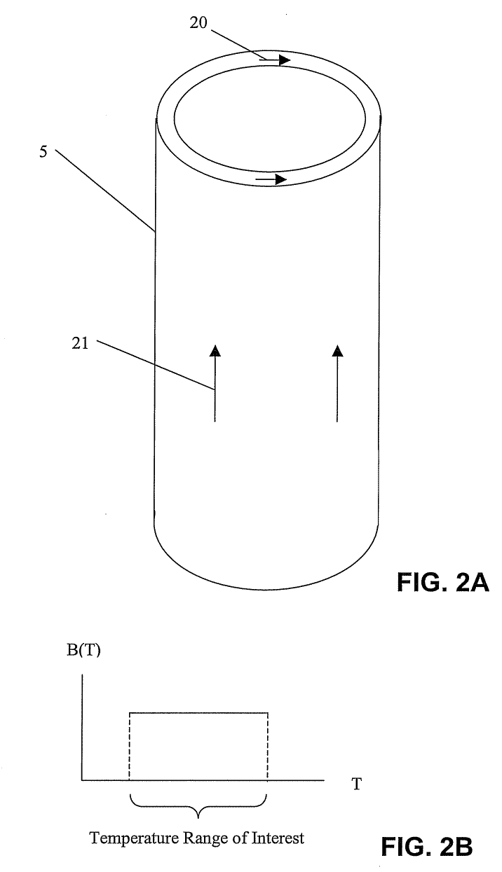

FIG. 2 illustrates an exemplary embodiment of the magnet 5. In the embodiment of FIG. 2A, the magnet 5 includes a hollow cylindrical shape. Magnetization of the magnet 5 is substantially in a transverse direction 20 or an axial direction 21 depending on the type of logging instrument 10. For example, the magnet in the MAGTRAK NMR LWD instrument is magnetized in the axial direction 21 to provide a low radial field gradient in the formation 4. The MAGTRAK instrument is produced by Baker Hughes Incorporated of Houston, Tex. The magnet 5 provides for magnetizing nuclei in a volume of investigation in the formations 4. Thus, the magnet 5 provides a “substantially” constant magnetic field magnitude in the volume of investigation through a range of temperatures in the borehole 2.

Referring to FIG. 2, exemplary embodiments of the magnet 5 may include samarium-cobalt (SmₓCo_{y}). Certain proprietary alloys are available that include SmₓCo_{y}. These proprietary alloys are available as RECOMA® STAB from Precision Magnetics LLC of Valparaiso, Ind., and make use of at least one of Sm₂Co₁₇ and SmCo₅. Another example of a material used to build the magnet 5 is neodymium-iron-boron (NdFeB). Other embodiments using SmₓCo_{y}, NdFeB, or other materials may be used where such materials exhibit desired properties for the magnet 5. For example, other rare elements such as Gadolinium (Gd) or Terbium (Tb) may be used to partially replace Sm in SmₓCo_{y}. In one embodiment, fifty percent of Sm is replaced with Gd. FIG. 2B depicts an exemplary temperature coefficient of the magnet 5 as the slope of the graph of magnetic field magnitude versus temperature of the magnet 5 over a temperature range of interest. Referring to FIG. 2B, the temperature coefficient is “substantially” zero.

High temperatures inside the borehole 2 can cause components of the logging instrument 10, such as the magnet 5, to thermally expand. A result of thermal expansion is a loss of magnetic field magnitude at a measurement location in the formation 4. In some embodiments, the magnet 5 can be built with a positive temperature coefficient to compensate for the loss of magnetic field magnitude due to thermal expansion of the logging instrument 10 or the magnet 5.

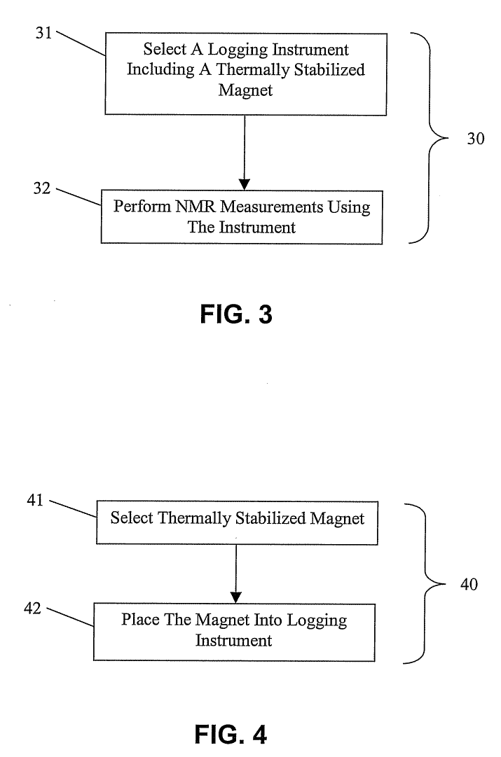

FIG. 3 presents an exemplary method 30 for performing NMR measurements in the borehole 2. The method 30 calls for selecting 31 the logging instrument 10 adapted for use in the borehole 2. The logging instrument 10 includes the thermally stabilized magnet 5. Further, the method 30 calls for performing 32 NMR measurements using the instrument 10.

FIG. 4 presents an exemplary embodiment 40 for producing the logging instrument 10 for performing an NMR measurement in the borehole 2. The method 40 calls for selecting 41 the thermally stabilized magnet 5. Further, the method 40 calls for placing 42 the thermally stabilized magnet 5 in the logging instrument 10.

The embodiments presented above are meant to be illustrative and not limiting of the teachings herein. For example, other embodiments may use more than one magnet. Further, the teachings include using magnets of various shapes. Examples include magnets that are at east one of cylindrical and rectangular shaped. While the embodiment of the logging instrument 10 presented in FIG. 1 is used to perform NMR measurements, it is appreciated that the magnet 5 can be used in the logging instrument 10 to perform other types of measurements or functions in the borehole 2 requiring a magnetic field with a “substantially” constant magnetic field magnitude through a range of temperatures.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A logging instrument for estimating a property of a formation penetrated by a borehole, the instrument comprising:
a magnet disposed at the instrument wherein the magnet exhibits a magnetic field of “substantially” constant magnitude over a range of temperatures in the borehole.

2. The instrument as in claim 1, wherein the instrument performs a nuclear magnetic resonance (NMR) measurement.

3. The instrument as in claim 2, wherein the magnetic field is applied to a volume of investigation in the formation.

4. The logging instrument as in claim 1, wherein the range comprises about 0° C. to about 200° C.

5. The logging instrument as in claim 4, wherein the range comprises about 20° C. to about 175° C.

6. The logging instrument as in claim 5, wherein the range comprises about 40° C. to about 150° C.

7. The instrument as in claim 1, wherein a temperature coefficient α for the magnet is determined as:
B(T)=B(T₀)(1+αΔT)
where: B(T) represents the magnitude of the magnetic field generated by the magnet, T represents the temperature of the magnet, T₀ represents a reference temperature, α represents the temperature coefficient, and ΔT represents a change in temperature (T−T₀) of the magnet.

8. The instrument as in claim 7, wherein the temperature coefficient is “substantially” zero.

9. The instrument as in claim 7, wherein the temperature coefficient is positive to compensate for thermal expansion of at least one of the logging instrument and the magnet.

10. The instrument as in claim 1, wherein the magnet comprises an alloy comprising at least one of Sm₂Co₁₇ and SmCo₅.

11. The instrument as in claim 10, wherein at least a portion of Sm is replaced by a different rare earth element.

12. The instrument as in claim 11, wherein the different rare earth element is at least one of Gadolinium (Gd) and Terbium (Tb).

13. The instrument as in claim 1, wherein the magnet comprises an alloy comprising NdFeB.

14. A method for performing a nuclear magnetic resonance (NMR) measurement in a borehole, the method comprising:
selecting a logging instrument adapted for use in the borehole, the instrument comprising a magnet that provides for a magnetic field of “substantially” constant magnitude over a range of temperatures in the borehole; and
performing the NMR measurement with the instrument.

15. A method for producing a logging instrument for performing a nuclear magnetic resonance measurement in a borehole, the method comprising:
selecting a magnet that provides for a magnetic field of “substantially” constant magnitude over a range of temperatures in the borehole; and
placing the magnet into the instrument.
